(19) United States
(12) Patent Application Publication
(10) Pub. No.: US 2004/0109198 A1
(43) Pub. Date: Jun. 10, 2004

(54) Printer and its printing method

(75) Inventors: Kazunori Ishii, Fukushima-ken (JP); Toru Yoshida, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/700,191

(22) Filed: Nov. 3, 2003

(30) Foreign Application Priority Data
Nov. 8, 2002 (JP) 2002-325082

(51) Int. Cl. G06F 15/00

(52) U.S. Cl. 358/1.15

(57) ABSTRACT

The invention provides a printer and its printing method for avoiding a complicated operation and able to simplify equipment and reduce cost. Therefore, when automatic printing information for automatically printing image data selected in advance is recorded to a recording medium, printing according to this automatic printing information is executed. In contrast to this, when the above automatic printing information is not recorded, at least one item of image data counted from the newest side is printed with reference to the making dates of the above image data.

### BACKGROUND OF THE INVENTION

1. Field of the Invention

The present invention relates to a printer and its printing method, and particularly relates to a printer and its printing method able to select and print arbitrary image data among plural image data recorded to a recording medium of an image processor such as a digital camera, etc.

2. Description of the Related Art

A printer was conventionally adopted as a means for printing image data made by the image processor such as a digital camera, etc.

When the image data are printed by such a printer, for example, the recording medium such as a memory card, etc. detachably arranged in the digital camera is connected to the printer. If automatic printing information such as so-called DPOF (Digital Print Order Format), etc. is recorded to this recording medium, the image data according to this automatic printing information are automatically selected, or a user selects the image data by a switch, etc. arranged in the printer.

[Patent Literature 1]

JP-A-2002-211082 (FIG. 1)

However, since the printer is constructed such that the user selects the image data desirous to be printed and inputs the image data to the printer, the operation is complicated and it is necessary to arrange a display device such as an LCD, etc. for confirming the selecting switch and the image data in the printer. Therefore, the problem of an increase in cost was caused.

### SUMMARY OF THE INVENTION

The present invention is made in consideration of such a problem and an object of the present invention is to provide a printer and its printing method for avoiding the complicated operation and able to simplify equipment and reduce cost.

To achieve the above object, the printer in the present invention is characterized in that printing according to automatic printing information for automatically printing image data selected in advance is executed when this automatic printing information is recorded to a recording medium, and at least one item of image data counted from the newest side is printed with reference to the making dates of the above image data when the above automatic printing information is not recorded.

In accordance with the adoption of such a construction, when no automatic printing information is recorded to the recording medium, it is possible to print at least the newest image data photographed just before and which would be normally desired to be printed by a user while avoiding a complicated operation and expensive equipment with respect to the printer.

Further, the printer in the present invention is also characterized in that the above recording medium is set to the recording medium of a digital camera.

In accordance with such a construction, the complicated operation is avoided and the equipment can be simplified and cost can be restrained even when the image data of the digital camera are printed.

Further, the printer in the present invention is characterized in that the above automatic printing information is a DPOF file.

In accordance with the adoption of such a construction, the image data can be simply selected by confirming the existence of the DPOF file spread in the digital camera, etc.

Furthermore, the printing method of the printer in the present invention is characterized in that printing according to automatic printing information for automatically printing image data selected in advance is executed when this automatic printing information is recorded to a recording medium, and at least one item of image data counted from the newest side is printed with reference to the making dates of the above image data when the above automatic printing information is not recorded.

In accordance with the adoption of such a construction, when no automatic printing information is recorded to the recording medium, it is possible to print at least the newest image data which would be normally desired to be printed by the user while avoiding the complicated operation and expensive equipment with respect to the printer.

### BRIEF DESCRIPTION OF THE DRAWINGS

FIG. 1 is a block diagram showing an embodiment mode of a printer in the present invention.

FIG. 2 is a view typically showing image data recorded to a recording medium in the embodiment mode of the printer in the present invention.

FIG. 3 is a flow chart showing an embodiment mode of a printing method of the printer in the present invention.

### DESCRIPTION OF THE PREFERRED EMBODIMENTS

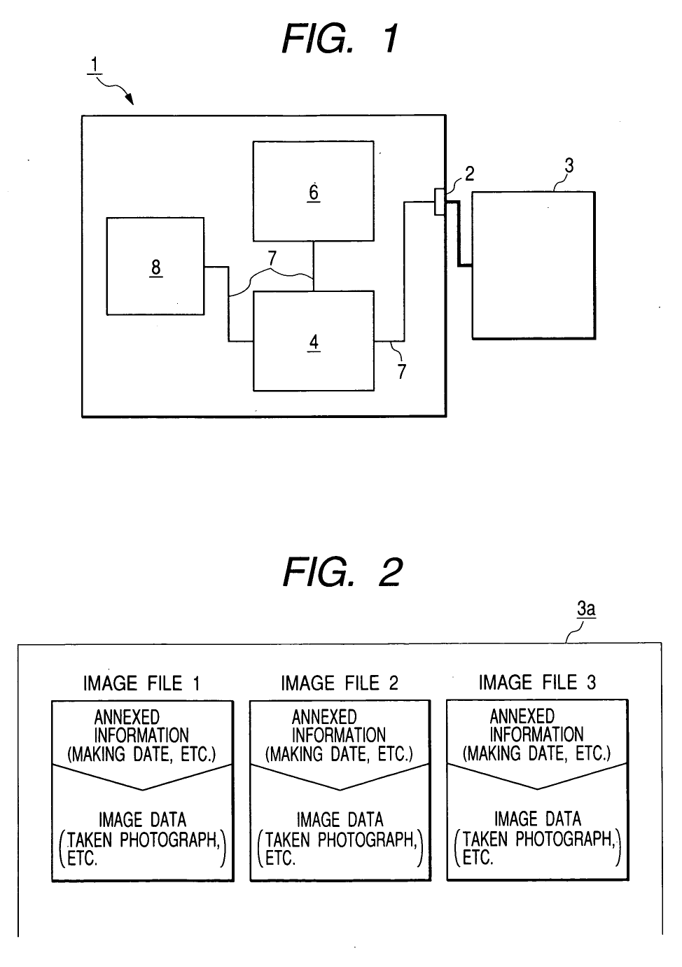

The embodiment modes of a printer and its printing method in the present invention will next be explained with reference to FIG. 1.

As shown in FIG. 1, the printer 1 in this embodiment mode has a connecting portion 2 such as a USB cable, etc., and is constructed such that an image processor 3 such as a digital camera, etc. is directly connected to the printer 1 through a cable so as to obtain plural image data recorded to a recording medium 3a such as a memory card, etc. mounted to the above image processor 3. For example, as shown in FIG. 2, the plural image data are recorded to this recording medium 3a as an image file together with annexed information such as respective making (photographing) dates, the sizes or titles of the images, etc.

Further, there is a case in which automatic printing information such as DPOF, etc. having the printed image data selected by the user in advance on the image processor side is recorded to the above recording medium 3a.

The printer 1 in this embodiment mode has a CPU 4 (central processing unit). This CPU 4 reads the image data recorded to the above recording medium 3a as an image file, and executes various controls for printing these image data.

An image data selecting section 6 is connected to the above CPU 4 through a bus 7, and the printed image data are definitely selected by this image data selecting section 6.

Namely, this image data selecting section 6 retrieves whether the above automatic printing information is recorded to the above recording medium 3a or not. When the automatic printing information is recorded to the recording medium 3a, the image data selected in this automatic printing information are definitely selected as the printed image data.

In contrast to this, when the above automatic printing information is not recorded to the above recording medium 3a, the above image data selecting section 6 compares the making dates of the respective image data with reference to the annexed information of the image file, and selects the image data of a newest making date as the printed image data.

A driving section 8 of the printer 1 is connected to the above CPU 4 through a bus 7. This CPU 4 outputs commands for printing the image data selected by the above image data selecting section 6 to this driving section 8.

A recording head 9 such as a thermal head, an ink jet head or a light emitting portion in the printer of an electrophotographic system, etc. is connected to the above driving section 8. The selected image data are printed by operating this recording head 9 by the above driving section 8.

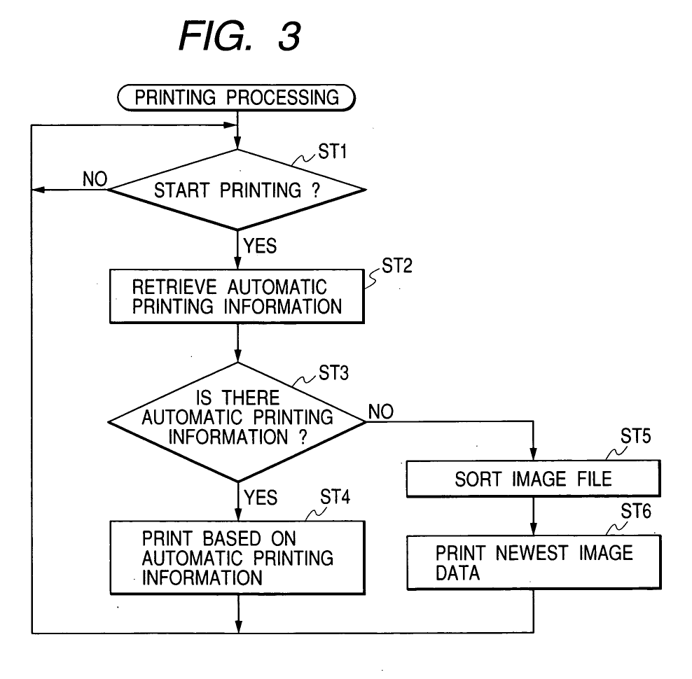

The printing method of the printer in the present invention applying the above printer 1 thereto will next be explained with reference to FIG. 3 focusing on image selection processing using the above image data selecting section.

In this embodiment mode, when the printing processing using the above printer 1 is performed, the existence of a printing start is first judged as shown in a step 1 (ST1). Thereafter, when the printing is started, it proceeds to a step 2 (ST2). In contrast to this, if no printing is started, the step 1 (ST1) is repeated.

In the step 2 (ST2), it is retrieved whether the automatic printing information such as DPOF, etc. is recorded to the above recording medium 3a. Subsequently, in a step 3 (ST3), the existence of the automatic printing information is judged. If the automatic printing information is recorded, it proceeds to a step 4 (ST4). In contrast to this, if no automatic printing information is recorded, it proceeds to a step 5 (ST5).

In the step 4 (ST4), the image data selected in advance are printed by a set number in accordance with the automatic printing information recorded to the recording medium 3a.

In the step 5 (ST5), the image files are sorted in the making date order. Thereafter, it proceeds to a step 6 (ST6). In this step 6 (ST6), only the image data of the image file of the newest making date among the sorted image files are printed.

Accordingly, in accordance with this embodiment mode, when the automatic printing information for automatically printing the image data selected in advance by the image data selecting section 6 of the printer 1 is recorded to the recording medium 3a, the printing according to this automatic printing information is executed. In contrast to this, when no automatic printing information is recorded, the newest image data can be printed by comparing the making dates of the respective image data.

As this result, when no automatic printing information is recorded to the recording medium 3a, it is possible to print the newest image data which would be normally desired to be printed by at least the user while avoiding the complicated operation and expensive equipment with respect to the printer 1.

The present invention is not limited to the above embodiment modes, but can be variously changed in accordance with necessity.

For example, with respect to the image data printed when no automatic printing information is recorded to the recording medium 3a, two image data or more sequentially counted from the newest image data may be also printed as well as the newest image data.

As mentioned above, in accordance with the printer and its printing method in the present invention, the complicated operation is avoided and equipment can be simplified and cost can be reduced.

What is claimed is:

1. A printer able to select and print arbitrary image data among plural image data recorded to a recording medium together with its making date,
wherein, when automatic printing information for automatically printing the image data selected in advance is recorded to said recording medium, printing according to this automatic printing information is executed, and when said automatic printing information is not recorded, the making dates of the respective image data are compared and at least one item of image data counted from the newest side is printed.

2. The printer according to claim 1, wherein said recording medium is set to the recording medium of a digital camera.

3. The printer according to claim 1 or 2, wherein said automatic printing information is set to a DPOF file.

4. A printing method of a printer for selecting and printing arbitrary image data among plural image data recorded to a recording medium together with its making date,
wherein, when automatic printing information for automatically printing the image data selected in advance is recorded to said recording medium, printing according to this automatic printing information is executed, and when said automatic printing information is not recorded, the making dates of the respective image data are compared and at least one item of image data counted from the newest side is printed.
